(19) United States
(12) Patent Application Publication
(10) Pub. No.: US 2015/0379559 A1
(43) Pub. Date: Dec. 31, 2015

(54) APPLICATION INSTALLATION CONVERSION AND IDENTIFICATION

(71) Applicant: GOOGLE INC., MOUNTAIN VIEW, CA (US)

(72) Inventors: Shobhit Saxena, Sunnyvale, CA (US); Vinod Kumar Ramachandran, Sunnyvale, CA (US); Lu Liu, San Jose, CA (US); Shibani Sanan, Saratoga, CA (US); Ying-Chieh Belinda Langner, Mountain View, CA (US)

(21) Appl. No.: 14/319,855

(22) Filed: Jun. 30, 2014

(51) Int. Cl. G06Q 30/02

(52) U.S. Cl. CPC G06Q 30/0246

(57) ABSTRACT

Methods, systems, and apparatus, including computer programs encoded on a computer storage medium, for detecting and utilizing conversion data are disclosed. In one aspect, a method includes receiving an indication of a user interaction with an advertisement presented at a user device; receiving a user identifier corresponding to the user device; determining that the first application was installed on the user device, based at least in part on a device identifier of the user device being received with installation data corresponding to the installation; receiving, from a second application installed on the user device, (1) the user identifier and (2) the device identifier of the user device; determining, based on receipt of the user identifier and device identifier from the second application that the installation of the first application is attributable to the user interaction.

### BACKGROUND

This specification relates to data processing and content distribution.

The Internet facilitates the exchange of information and transactions between users across the globe. This exchange of information enables content item providers to provide sponsored content to a variety of users. Users often engage in commercial transactions in response to viewing or otherwise receiving sponsored content, and the effectiveness of sponsored content items can be evaluated, at least in part, by identifying when a commercial transaction has occurred in response to presentation of a particular sponsored content item.

### SUMMARY

In general, one innovative aspect of the subject matter described in this specification can be embodied in methods that include the actions of providing, for presentation at a user device, an advertisement for a first application; receiving (1) an indication of a user interaction with the advertisement that was presented at the user device and (2) a user identifier corresponding to the user device; storing the indication of the user interaction in association with the user identifier; determining, by one or more data processing apparatus, that the first application was installed on the user device, based at least in part on a device identifier of the user device being received with installation data corresponding to the installation, the device identifier being different from the user identifier; receiving, from a second application installed on the user device, (1) the user identifier and (2) the device identifier of the user device; determining, based on the determination that the first application was installed on the user device, receipt of the user identifier and device identifier from the second application and the stored association between the user identifier and the user interaction with the advertisement, that the installation of the first application is attributable to the user interaction; and recording, in response to the determination that the installation of the first application is attributable to the user interaction, a conversion for the advertisement in a database. Other embodiments of this aspect include corresponding systems, apparatus, and computer programs, configured to perform the actions of the methods, encoded on computer storage devices.

These and other embodiments can each optionally include one or more of the following features. The first application can be distinct from the second application. The user identifier can be a unique user ID for a user account. The user account can be a user account for at least one of an email service, a photo sharing service, a video sharing service, or a social network. The user can be logged in to the user account when the indication of the user interaction with the advertisement and the user identifier are received. The stored indication of the user interaction and the associated stored user identifier can be deleted in response to determining that the installation of the first application is attributable to the user interaction. A record of the device identifier can be deleted in response to determining that the installation of the first application is attributable to the user interaction.

Particular embodiments of the subject matter described in this specification can be implemented so as to realize none, one or more of the following advantages. User privacy can be facilitated by preventing the persistent mapping of user identifiers with device identifiers. User privacy can additionally be facilitated by allowing users to control identification settings and application installation conversion identification settings. Sponsored content item presentations can be mapped to application installation occurrences in a user privacy preserving manner. Content sponsors can receive accurate information on the effectiveness of advertising campaigns. Content sponsors can be accurately charged for successful conversions. The system avoids persistent mapping between user identifier spaces.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which application installation conversions can be identified.

FIG. 2 is a block diagram of an example data flow for identifying application installation conversions.

FIG. 3 is a flow chart of an example process for identifying application installation conversions.

FIG. 4 is a block diagram of an example computer system.

Like reference numbers and designations in the various drawings indicate like elements.

### DETAILED DESCRIPTION

A content distribution system (e.g., an advertising exchange) that distributes content items (e.g., advertisements) in an online environment provides sponsored content items to user devices for presentation with a publisher resource. For example, a content distribution system can receive a request for content items, such as a request for advertisements, that will be displayed with a publisher resource, such as a webpage. Content items can be displayed along with publisher resources (such as webpages) within a browser application on a user device, or displayed alongside other content within a native application installed on the user device.

A user of the user device can interact with a provided content item to initiate a commercial transaction. For example, the content distribution system can transmit an advertisement for a mobile application to a user device. The advertisement can then be displayed in a browser installed on the mobile device alongside publisher content. The user of the user device can select (e.g., interact with) the advertisement, which can cause the user to be directed to an application store that allows the user to purchase the application advertised by the advertisement. The user can then purchase the application and install the application on the user device.

In some implementations, the user can login to an account that is associated with the content distribution system. For example, the content distribution system can provide services in addition to providing content items, such as providing email services, web search services, social networking services, video sharing services, file sharing services, or other services. As another example, the content distribution system can be associated with other service providers that provide services that require users to login, or that allow users to login to access enhanced features. For example, a video posting and sharing service can be associated with the content distribution system. The video posting and sharing service can allow users to create user profiles that allow users to create video “channels” and post videos to the channels. The video posting and sharing service can require that users login using a username and password in order to access their profiles. As another example, the content distribution system can also provide an email service that requires users to login using a username and password in order to access and send emails for a particular email address. In some situations, a single login can enable the user to access any of the services provided by an entity that operates the content distribution system, or by one or more entities associated with the content distribution system.

When a content item is provided for presentation at the user device by the content distribution system, the user can select (e.g., interact with) the content item to initiate a commercial transaction. The selection of the content item by the user can cause the user to be directed to an application store that allows the user to purchase an application advertised by the content item. The selection of the content item by the user can also cause the user device to transmit a notice to the content distribution system indicating that the user has interacted with the content item (e.g., by selecting the content item). If the user is logged into an account that is associated with the content distribution system, the notice transmitted from the user device to the content distribution system can also include a first user identifier for the associated account. For example, a user can have an account for a video sharing service associated with the content distribution system, and be logged into the account at the time the user interacts with the content item. The video sharing service can assign a unique identifier (e.g., a random string of numbers, letters, and/or other characters) to the user's account to allow the video sharing service to uniquely identify the user's account from other user accounts for the video sharing service. The user device can send a notice to the content distribution system indicating the unique identifier for the user's account and that the user has interacted with the content item. The content distribution system can then associate the interaction with the received first user identifier in memory, such as in a database.

The user can then purchase or otherwise download the advertised application (e.g., from an application store), and install the application on the user device. Upon installation of the application, code included as part of the application, or associated with the application, can cause the user device to transmit a notice to the content distribution system indicating that the application has been installed on the user device, and further indicating a device identifier for the user device. In some implementations, the notice is only transmitted if user preferences indicate that the user has opted to allow application installation information to be shared with the content distribution system. The device identifier can be, for example, a unique string of alphanumeric characters that is specific to the user device. The content distribution system can store the installation notice in association with the device identifier for the user device.

Later, the user can access a native application on the user device and login into the account associated with the content distribution system using the native application. For example, the user can start a native application for the video sharing service on the user device and login using the username “example username.” The native application can transmit requests and other communications to the content distribution system (for example, requests for videos, or requests for advertisements to display in the native application). The information transmitted to the content distribution system can include an indication of a first user identifier for the user (e.g., a string of random characters used to uniquely identify the user's account from among other user accounts) and an indication of the device identifier for the device. The content distribution system can use the received user identifier to determine that the user had previously interacted with the content item advertising the recently installed application, and then use the received device identifier to determine that the application was in fact installed on the user device. The content distribution system can then log a conversion for the content item by identifying that the interaction with the content item lead to a successful installation of the advertised application. Information relating to the first user identifier and the device identifier is then deleted, without the first user identifier and the device identifier ever being permanently stored together at the content distribution system.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. Users are also able to control whether or not information regarding the installation of applications on a user device is provided to a content distribution network or other entity. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

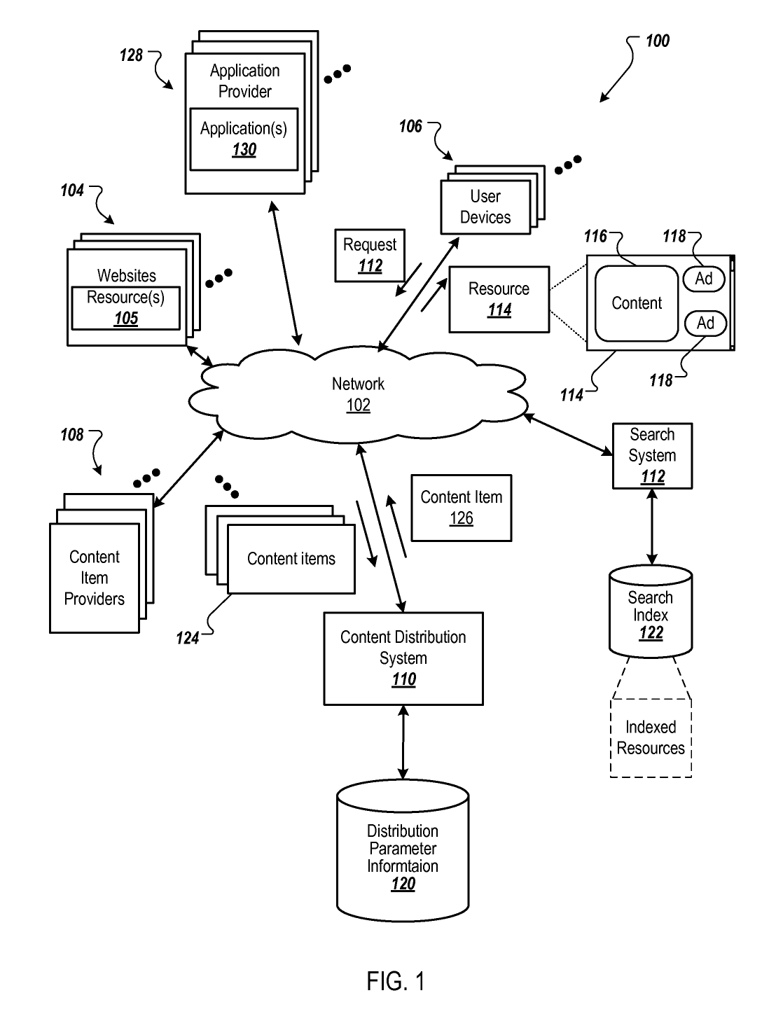

FIG. 1 is a block diagram of an example environment 100 in which content is distributed to user devices 106. The example environment 100 includes a network 102, such as a local area network (LAN), a wide area network (WAN), the Internet, or a combination thereof. The network 102 connects websites 104, user devices 106, content item providers 108, and a content distribution system 110. The example environment 100 may include many different websites 104, user devices 106, and content item providers 108.

A website 104 is one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a publisher, which is an entity that controls, manages and/or owns the website 104.

A resource 105 is any data that can be provided over the network 102. A resource 105 is identified by a resource address that is associated with the resource 105. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as scripts). Units of content that are presented in (or with) resources are referred to as content items, and an individual content item can be stored in a single file or set of files independent of the resource. In some implementations, multiple content items can be stored in a single file.

A user device 106 is an electronic device that is capable of requesting and receiving resources over the network 102. Example user devices 106 include personal computers, tablet devices, mobile communication devices, and other devices that can send and receive data over the network 102. A user device 106 typically includes a user application, such as a web browser, to facilitate the sending and receiving of data over the network 102.

A user device 106 can submit a resource request 112 that requests a resource 105 from a website 104. In turn, data representing the requested resource 114 can be provided to the user device 106 for presentation by the user device 106. The requested resource 114 can be, for example, a home page of a website 104, web page from a social network, or another resource 105. The data representing the requested resource 114 can include data that cause presentation of resource content 116 at the user device 106. The data representing the requested resource 114 can also include data specifying content item slots 118. A content item slot is a portion of the resource (e.g., a portion of a web page) or a portion of a user display (e.g., a presentation location of another window or in a slot of a web page) in which content items, such as advertisements, can be presented. Content items slots 118 can also be referred to as advertisement slots, but any type of content (e.g., content items other than advertisements) can be presented in these content item slots 118.

To facilitate searching of these resources, the environment 100 can include a search system 112 that identifies the resources by crawling and indexing the resources provided by the publishers on the websites 104. Data about the resources can be indexed based on the resource with which the data are associated. The indexed and, optionally, cached copies of the resources are stored in a search index 122. Data that are associated with a resource is data that represents content included in the resource and/or metadata for the resource.

User devices 106 can submit search queries to the search system 112 over the network 102. In response, the search system 112 accesses the search index 122 to identify resources that are relevant to the search query. The search system 112 identifies the resources in the form of search results and returns the search results to the user device in search results page. A search result is data generated by the search system 112 that identifies a resource that is responsive to a particular search query, and includes a link to the resource. An example search result can include a web page title, a snippet of text or a portion of an image extracted from the web page, and the URL of the web page. Like other resources, search results pages can include one or more content item slots in which content items, such as advertisements, can be presented.

The search system 112 can optionally allow users to create accounts to provide enhanced searching functions. For example, a user can create a user account for the search system 112 and log in to the user account using a username and password. The search system 112 can then provide enhanced features for the user in association with the users account by, for example, keeping track of frequently used search terms for the user. As another example, the search system 112 can allow a user to log in to his account to access “favorite” websites, custom content that is identified based on user preference information provided by the user, or other content associated with the user account from any device.

When a resource 105 is requested by a user device 106, execution of code associated with a slot in the resource initiates a request for a content item to populate the slot. The request can include characteristics of the slots that are defined for the requested resource 114 as well as content item selection criteria associated with the requested resource 114. For example, a reference (e.g., URL) to the requested resource 114 for which the slot is defined, a size of the slot, and/or media types that are eligible for presentation in the slot can be provided to the content distribution system 110. Similarly, keywords (phrases of one or more words) associated with a requested resource (“resource keywords”) or entities that are referenced by the resource can also be provided to the content distribution system 110 to facilitate identification of content items that are relevant to the requested resource 114. In some implementations, the content distribution system 110 can parse the requested resource 114 to identify keywords based on content of the resource 114. The requests can also include other selection criteria, such as information that the user has provided, geographic information indicating a state or region from which the request was submitted, or other information that provides context for the environment in which the content item will be displayed (e.g., a type of device on which the content item will be displayed, such as a mobile device or tablet device).

The content items that are provided in response to a request (or another content item request) are selected based at least in part on distribution parameters associated with the content items. Distribution parameters are a set of criteria upon which distribution of content items are conditioned. In some implementations, the distribution criteria for a particular content item can include distribution keywords that must be matched (e.g., by resource keywords or search queries) in order for the content item to be eligible for presentation. In some implementations, the content distribution system 110 can access distribution parameter information 120 to identify distribution parameters associated with a given content item. The distribution criteria can also specify a bid and/or budget for distributing the particular content item. In some implementations, bids can be used in an auction to select which content item(s) will be presented and/or in which slot the content item(s) will be presented. A content item provider can specify a budget, which will limit the maximum amount that the content item provider will spend over a specified period. A content item provider can also specify a maximum amount to pay for a particular impression.

The content distribution system 110 uses the specified distribution parameters to distribute content items 124 provided by the content item providers 108 on behalf of the content item providers 108. For example, the content distribution system 110 can select a content item from the content items 124 as being a best match for the specified distribution parameters and provide the selected content item to the user device 106 as a content item 126 for presentation along with the resource 114 in the single content item slot 118. In some implementations, providing the content item 126 to the user device 106 includes providing a reference to the content item 106 (e.g., a URL or other network address) to the user device 106 to allow the user device 106 to retrieve the content item 126 for presentation along with the resource 114 in the single content item slot 118.

The content distribution system 110 also stores interaction data specifying, for example and for each impression, whether a user interacted with (e.g., clicked) the content item. For example, when a user clicks on a content item, code included in the content item can initiate a request for a landing page referenced by the content item. Code included in the content item can also cause data representing the interaction to be transmitted to the content distribution system 110. In some cases, the content distribution system 110 can associate the data representing the interaction with a user identifier for a user who interacted with the content item. For example, the interaction can be associated with a unique identifier for the user that is used to uniquely identify a user account of the user for a service provided by or associated with the content distribution system 110. For example, the content distribution system 110 can be associated with the search system 112. A user can login to a user account associated with the search system 112 (as described above) and a subsequent user interaction with the content item by the user can be logged along with the a unique identifier used to identify the user's account for the search system 112 from among other user accounts for the search system 112.

In some implementations, the content item 126 can be an advertisement for an application, such as a mobile application for installation on a mobile device. The content item 126 is provided to the user device 106 for display along with the resource 114 in one of the content item slots 118. A user of the user device 106 can select the displayed content item 126, or otherwise interact with the displayed content item 126. User interaction with the displayed content item 126 can cause the user to be directed to an application store that allows the user to purchase or download the advertised application. For example, the user can be directed toward an application store maintained by one or more application providers 128. When the user selects or otherwise interacts with the content item 126, a notice can be transmitted from the user device 106 to the content distribution system 110 indicating that the user has interacted with the content item 126, and also indicating a user identifier for the user.

The user can then access the advertised application (e.g., through the application store) and receive a download of the application 130 from the application provider 128. The user then installs the application 130 on the user device 106. Upon installation of the application 130, code included as part of the application 130, or associated with the application 130, can cause the user device 106 to transmit a notice to the content distribution system 110 indicating that the application 130 has been installed on the user device 106, and further indicating a device identifier for the user device 106 (the device identifier being distinct from the user identifier). The device identifier can be, for example, a unique string of alphanumeric characters that is specific to the user device 106, while the user identifier can be a different unique string of alphanumeric characters that uniquely identifies the user from among other users. The content distribution system 110 can store the installation notice in association with the device identifier for the user device 106.

The user can later access a native application on the user device 106 and log in to a service using the native application. For example, the search system 112 can provide a native application that is installed on the user device 106 and allows the user to access search services provided by the search system 112. The user can optionally log in to the search service using the native application. The native application can then cause the user device 106 to transmit information to the content distribution system 110 indicating the user identifier used to log in to the native application and the device identifier for the user device 106. The content distribution system 110 can then use the received user identifier and device identifier to log a conversion for the content item 126 indicating that the application was downloaded by a user that previously interacted with the content item 126.

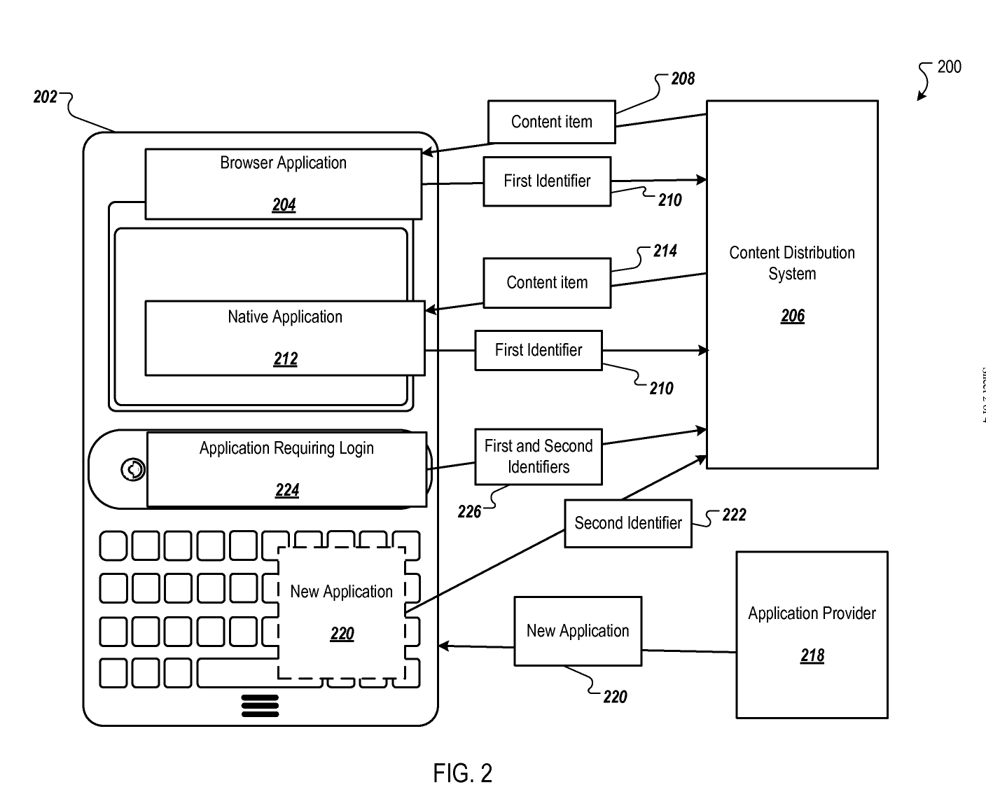

FIG. 2 is a block diagram of an example data flow 200 for identifying application installation conversions. For purposes of example, FIG. 2 is described with reference to user interaction with an advertisement that leads to a user installation of an application that was advertised by the advertisement. The data flow 200 is also applicable to user interactions with other types of content items (e.g., audio/video files or content items presented in a social network environment).

The data flow 200 begins with a user accessing a browser application 204 installed on a user device 202. In the example shown, the user device 202 is depicted as a mobile phone. However, the user device 202 can alternatively be a tablet device, PDA, laptop computer, desktop computer, GPS unit, smart watch, or any other mobile or non-mobile user device. The user can use the browser application 204 to access resources such as webpages. When a resource loads within the browser application 204, the browser application 204 can generate a request for one or more content items to display in content item slots along with the resource, as described above with reference to FIG. 1. The user device 202 transmits the request to a content distribution system 206.

In response to the request, the content distribution system 206 provides a content item 208 for presentation along with the resource. In some implementations, the user of the user device 202 can log in to a user account for one or more services using the browser application 204. This login can occur either prior to the request for the content item and presentation of the content item 208 on the user device 202, or after the content item 208 has been presented on the user device 202 by the browser application 204. For example, the user can log in to an email account using the browser application 204 using a username or other user ID and password. The user can access and send emails using the email account. As another example, the user can log in to a social network account using the browser application 204. As yet another example, the user can log in to an account for a search service, a video sharing service, a picture sharing service, or any other service that allows users to create an account and/or log in. As yet another example, the user can log in to an account for the browser application 204 in order to access saved “favorite” websites, search history, browser or search preferences, or other information. The browser application 204 can allow for users to create accounts and log in so that such user specific information can be shared across multiple devices. For example, the user can add a website to his list of favorites from a browser on a desktop computer (while the user is logged into the browser) and then later log in to the browser application 204 to access the list of favorites including the recently added website.

While the user is logged in to the user account, (e.g., the user has previously logged into the user account, and has not logged out of the user account) the user can interact with the content item 208. For example, the user can select (e.g., interact with) the content item 208 within the browser application 204 using a touch screen, mouse, trackball, touch pad, or other input device. As another example, the user can interact with the content item 208 using voice commands recognized by a microphone and voice processing software of the user device 202.

Upon user interaction with the content item 208, the browser application 204 can cause the user device 202 to transmit information to the content distribution system 206 indicating that the user has interacted with the user device and indicating a first identifier 210 for the user. The first identifier 210 can be, for example, a user identifier for the user account. For example, the first identifier 210 can be a string of alphanumeric characters that is associated with the user's user account that can be used to uniquely identify the user's user account from other user accounts. In some implementations, the first identifier 210 is distinct from a device ID for the user device 202. For example, the browser application 204 may not have access to a device ID for the user device 202, but does have access to the first identifier 210 in the form of a unique identifier for the user account to which the user is currently logged in.

The first identifier 210 can be used to uniquely identify the user (from among other users), but may not necessarily be associated with additional information for the user. For example, the user may not have provided any personal information, but only registered using a username and password.

The content distribution system 206 can store the first identifier 210 for the user in association with the user interaction with the content item 208. For example, an identifier for the content item 208 can be associated with the first identifier 210 in a database of content item interactions. In some implementations, a time stamp indicating the date and time that the user interacted with the content item 208 can be stored along with the first identifier 210 and the identifier for the content item 208.

In some alternate implementations, instead of, or in addition to, accessing content using the browser application 204, the user can access content using a native application 212 installed on the user device 202. For example, the native application 212 can be a social network application installed on the user device 202, and the user can access content using the native application 212 such as a newsfeed of updates from other users. As another example, the native application 212 can be a video sharing application that allows the user to search for, view, upload, and share videos with other users. As yet another example, the native application 212 can be a news application that allows the user to access news articles published by one or more news outlets.

In some implementations, the native application 212 allows the user to log in using a username and password in order to access a user account. For example, if the native application 212 is a social network application, the user can log in using a username and password to access the user's social network account and receive updates for other users having accounts linked to the user's account within the social network. As another example, the native application 212 is a video sharing application that allows the user to log in in order to post videos, create video “channels,” comment on other videos, or share videos with other selected users.

In addition to resources (e.g., user updates displayed in a newsfeed, videos, photos, news articles, etc.) presented by the native application 212, the user can also be presented with content items (e.g., advertisements) provided by the content distribution system 206 and displayed within the native application 212 alongside the resources. For example, the user can search for and select a video using the native application 212. The native application 212 can then cause the user device 202 to transmit a request for a video content item to the content distribution system 206. The content distribution system 206 can then provide the content item 214 to the user device 202 in response to the request. The content item 214 can then be presented to the user by the native application 212 prior to presentation of the selected video. As another example, the content item 214 can be presented on a portion of the screen of the user device 202 alongside the selected video as the selected video is being presented.

After the content item 214 has been presented to the user, the user can select or otherwise interact with the content item 214 to initiate a commercial transaction. For example, the content item 214 can be an advertisement for an application. The user can select the content item 214 to access an application store that allows the user to purchase and/or download the application for installation on the user device 202.

When the user selects or interacts with the content item 214, the native application 212 can cause the user device 202 to transmit information regarding the user interaction to the content distribution system 206. The information can include an indication that the user interacted with the content item 214 as well as the first identifier 210 for the user. The information can, in some implementations, also include an identifier for the content item 214. As described above, the first identifier 210 can be a user ID that uniquely identifies the user from among other users. The first identifier 210 can be, but is not necessarily, a unique user ID (e.g., randomly assigned string of characters) associated with the user's account for a service associated with the native application 212. For example, the first identifier 210 can be a username used by the user to log in to an account for the native application 212. As another example, the first identifier 210 can be a user ID associated with the user's account for the native application 212.

The content distribution system 206 can store the first identifier 210 for the user in association with the user interaction with the content item 208. For example, an identifier for the content item 208 can be associated with the first identifier 210 in a database of content item interactions. The content distribution system 206 can later access the database to identify that the user previously interacted with the content item 208. In some implementations, a time stamp indicating the date and time that the user interacted with the content item 208 can be stored along with the first identifier 210 and the identifier for the content item 208.

As mentioned above, the user can interact with the content item 208 and/or the content item 214 to access an application store or other system that allows the user to purchase and/or download a new application 220 being advertised by the content item 208 and/or the content item 214. For example, the user selects the content item 208 displayed within the browser application 204 and is directed to an application store for an application provider 218. The user can purchase the new application 220 (or, in the case of a free application, elect to download the application). The application provider 218 then transmits the new application 220 to the user device 202 for installation on the user device 202. The user may initiate installation of the new application 220 on the user device 202 at the time of download, or may save the downloaded new application 220 on the user device 202 for later installation.

At the time of installation of the new application 220, code included as part of the new application 220 or included in an installation script for the new application 220 can cause the user device 202 to transmit information regarding the installation to the content distribution system 206. For example, the application provider 218 may have a commercial relationship with the content distribution system 206 by which the content distribution system 206 provides advertisements to user devices (such as the content items 208 and 214) advertising applications being sold by the application provider 218. The application provider 218 can subsequently include installation detection code with applications provided by the application provider 218 that causes transmission of installation information to the content distribution system 206 to allow the content distribution system 206 to determine when applications provided by the application provider 218 are installed on user devices. For example, a software development kit integrated into the new application 220 can cause the user device 202 to “ping” the content distribution system 206 with installation information for the installation of the new application 220.

The information regarding installation of the new application 220 transmitted from the user device 202 to the content distribution system 206 can include an indication that the new application 220 has been installed on the user device 202 and further include a second identifier 222 identifying the user device 202. The second identifier 222 can be a device ID that is unique to the user device 202. In some implementations, the second identifier 222 can be a string of alphanumeric characters that uniquely identifies the user device 202 from among other user devices. In some implementations, the information regarding installation of the new application 220 that is transmitted to the content distribution system 206 can include an identifier for the new application 220.

The content distribution system 206 can store the second identifier 222 for the user device 202 in association with the installation of the new application 220. For example, an identifier for the new application 220 can be associated with the second identifier 222 in a database of application installations. The content distribution system 206 can later access the database to identify that the new application 220 had previously been installed on the user device 202 (as identified by the second identifier 222). In some implementations, a time stamp indicating the date and time that the new application 220 was installed can be stored along with the second identifier 222 and the identifier for the new application 220.

In some implementations, the second identifier 222 is only associated with the installation of the new application 220 within the database of application installations if an advertising campaign for the new application 220 is currently being conducted by the content distribution system 206. For example, if the content distribution system 206 is not currently providing content items (e.g., advertisements) advertising the new application 220, the installation of the new application 220 will not be associated with the second identifier 222 within the database of application installations. In some implementations, associations between the new application 220 installation and the second identifier 222 are only stored in the database of application installations for a specified set of applications. If the new application 220 is not included within the specified set of applications, the association between the installation of the new application 220 and the second identifier 222 is not stored in the database of application installations.

After the content distribution system 206 has recorded that the new application 220 was installed on the user device 202 (e.g., by associating the second identifier 222 with an identifier for the new application 220 in the application installation database) the user can access an application requiring login 224. In some implementations, the application requiring login 224 can be the same application as the native application 212. In some implementations, the application requiring login 224 and the native application 212 are distinct applications installed on the user device 202. The application requiring login 224 need not have been installed on the user device 202 prior to installation of the new application 220.

In some implementations, the user logs into the application requiring login 224 using a username and password to access a user account for the user. The user account can be associated with one or more services accessed by the user using the browser application 204 and/or the native application 212. For example, several associated services may allow the user to log into accounts using the same username and password across the various accounts. As another example, a single user account can allow the user to access multiple services. For example, the user can log in to an email account using the browser application 204. This login can also allow the user to access a social network, an account for a search service, an account for a video sharing service, and an account for a photo sharing service. As another example, the user can log in to an email service through the browser application 204 using a username and password. The user can then use the same username and password to log into the native application 212, which can be, for example, a social network application. The user can further use the same username and password to log into the application requiring login 224, which can be, for example, a video sharing application.

In some implementations, the user may have a different username and/or password for each of the accounts associated with the various services, but a common user ID for the user may be shared across the various services. For example, user may have a username of “email_username” for the email service, a username of “video_account_username” for the video sharing service and a username of “social_account_username” for the social network, but each account is linked by a common user ID associated with the user. The common user ID can be, for example, a string of random numbers, letters, and/or other characters that is used to uniquely identify the user's accounts from other accounts associated with the various services.

The user logs into the application requiring login 224 using a username and password, as described above. The application requiring login 224 may then send a transmission 226 to the content distribution system 206. For example, if the application requiring login 224 is a video sharing application, the transmission 226 may be a request for video content. As another example, if the application requiring login 224 is a social network application, the request may be a request for newsfeed information showing updates for the user's social network contacts. As yet another example, the transmission 226 can be a request for a content item (e.g., advertisement) intended for presentation along with other content, such as a publisher resource.

The application requiring login 224 is able to access the first identifier 210 for the user due to the user having logged in to the application requiring login 224. The application is also able to access the second identifier 222 for the user device 202 since the application requiring login 224 is installed on, and accessed from, the user device 202. The application requiring login 224 can cause the user device 202 to transmit the first and second identifiers 210 and 222 along with the transmission 226 to the content distribution system 206. In some implementations, the transmission 226 can be independent of other transmissions sent to the content distribution system 206 by the application requiring login 224. For example, the transmission 226 may only include the indications of the first and second identifiers 210 and 222.

Upon receiving the transmission 226 that include indications of the first and second identifiers 210 and 222, the content distribution system 206 can use the content distribution system 206 to determine that the user previously interacted with the content item 208 (or alternatively, with the content item 214) and that the new application 220 was previously installed on the user device 202. For example, the content distribution system 206 can access the database of content item interactions and use the first identifier 210 provided by the application requiring login 224 to determine that the user previously interacted with the content item 208. The content distribution system 206 can also access the database of application installations and use the second identifier 222 provided by the application requiring login 224 to determine that the new application 220 was previously installed on the user device 202.

The content distribution system 206 can associate the first identifier 210 with the second identifier 222 in a non-persistent manner due to the fact that the first and second identifiers 210 and 222 were both included in the transmission 226. In some implementations, the association between the first identifier 210 and the second identifier 222 is not stored by the content distribution system 206. This allows the content distribution system 206 to avoid creating a direct association between the first identifier 210 and the second identifier 222.

The content distribution system 206 uses this non-persistent association to determine that the user interaction with the content item 208 (or alternatively, the content item 214) led to the user installing the new application 220 on the user device 202. The content distribution system 206 can then log a conversion for the content item 208. The conversion can be an indication that a presentation and subsequent user interaction with the content item 208 led to a successful installation of the new application 220.

In some implementations, the conversion is only logged if an association between an application installation and the second identifier 222 is stored in the database of application installations and an association between a user interaction with an advertisement for the application and the first identifier 210 is stored in the database of content item interactions. In such implementations, if one of these associations is not found within the respective database, a conversion is not logged.

After the conversion has been logged, the information indicating an association between the content item 208 (or the content item 214) and the first identifier 210 can be removed from the database of content item interactions and the information indicating an association between installation of the new application 220 on the user device 202 and the second identifier 222 can be removed from the database of application installations. In some implementations, this process includes deleting all information associated with the second identifier 222 from the content distribution system 206 (including all information associating the second identifier 222 with application installations). In some implementations, the second identifier 222 can be associated with several different application installations within the database of application installations. When the transmission 226 is received from the user device 202, all of the application installations for the second identifier 222 can be identified and conversions for the identified application installations can be logged. After logging of these conversions, the information associated with the second identifier 222 may be deleted from the database of application installations.

The content distribution system 206 can use conversion detection information to identify conversions for various content items provided by the content distribution system 206 and for multiple applications provided by the application provider 218 and for other application providers. This conversion detection information can allow the content distribution system 206 and the application provider 218 determine the success of various advertising campaigns by allowing the parties to identify, for example, which advertisements lead to higher rates of application purchase and installation. The conversion detection information can also be used by the content distribution system 206 to accurately bill the application provider 218, as billing can be partially or completely based on the number of application installations that occur in response to presentation of particular advertisements. For example, the content distribution system 206 can charge the application provider 218 a set fee for each conversion that occurs (e.g., for each installation of the new application 220 on a user device following user interaction with an advertisement for the new application 220 provided by the content distribution system 206).

In some implementations, the user is allowed to reset the second identifier 222 (the device ID for the user device 202). Such a reset function allows information associated with the old device ID for the user device 202 to be dis-associated from the user device 202, as the user device 202 will be associated with a new device ID going forward after the reset. In some implementations, the user can reset the device ID after interaction with the content item 208 (or the content item 214) but prior to installation of the new application 220. In such circumstances, a conversion for the installation of the new application 220 can still be logged since upon installation of the new application 220, the new device ID will be provided to the content distribution system 206 as the second identifier 222. Later, when the transmission 226 is sent from the application requiring login 224, the transmission 226 will also include the new device ID as the second identifier 222 (along with the first identifier 210). Since both the transmission from the installation of the new application 220 and the transmission 226 use the new device ID as the second identifier 222, the conversion can be detected by the content distribution system 206 and logged.

In some implementations, associations between first identifiers (user identifiers) and user interactions with application stored in the database of content item interactions, and/or associations between second identifiers (device identifiers) and application installations stored in the database of application installations can be deleted after a specified period of time. For example, associations stored in the database of content item interactions can be given a time to live (TTL) of 30 days. If a conversion for a particular association stored in the database of content item interactions has not been logged within the TTL, the association may be deleted from the database of content item interactions. As another example, associations stored in the database of application installations can be given a TTL of 45 days. If a conversion is not logged for a particular association within the TTL, the association may be deleted from the database of application installations without a conversion being logged.

In some implementations, rather than being a user ID that is specific to the user of the user device 202, the first identifier 210 can be an application identifier that is specific to an application, or a particular instance (or install) of the application. For example, the native application 212 can be a search application, and the content item 214 can be an advertisement for the new application 220 that is presented along with search results displayed by the native application 212. Upon user interaction with the content item 214, the application identifier is provided to the content distribution system 206 as the first identifier 210. The application identifier is then associated with the user interaction with the content item 214 in the database of content item interactions by the content distribution system 206.

Later, after installation of the new application 220 and association of the installation with the second identifier 222 (a device identifier) within the database of application installations, the user can access the native application 212 again. Upon this accessing of the native application 212 that occurs after the installation of the new application 220, the native application 212 can provide the first and second identifiers 210 and 222 to the content distribution system 206, with the first identifier 210 being an application identifier specific to the native application 212 rather than a user identifier specific to the user in this situation. The content distribution system 206 can then use the provided first identifier 210 (application specific identifier) and second identifier 222 (device identifier) to log a conversion for the application installation as described above.

In some implementations, some application installations cannot be detected, but the content distribution system 206 can use information for conversions that are detected to calculate a total number of conversions that accounts for conversions that are not detected. For example, to calculate a total number of conversions for a given content item, the content distribution system 206 can identify a total number of user interactions with the content item for which a first identifier has been received, and can also determine the total number of user interactions with the content item for which a first identifier was not received by the content distribution system 206. The content distribution system 206 can then identify the ratio, or proportion, of user interactions with the content item for which a first identifier was received (e.g., the number of user interactions with the content item for which a first identifier was received divided by the total number of user interactions with the content item). The number of detected conversions can then be divided by the ratio to calculate the total number of conversions for the content item.

In some implementations, some user devices may not have an application requiring login (e.g., the application requiring login 224) installed. The content distribution system 206 can use information for conversions that are detected for user devices that have an application requiring login to calculate a total number of conversions that accounts for user devices that do not have an application requiring login installed. For example, the content distribution system 206 can identify a total number of user interactions with the content item that occurred on user devices having an application requiring login, and a total number of user interactions with the content item that occurred on user devices that do not have an application requiring login installed. The content distribution system 206 can then use this information to determine a ratio of user devices having an application requiring login to all user devices for which an interaction with the content item occurred. The number of detected conversions can then be divided by this ratio to calculate the total number of conversions for the content item. For example, if only 20% of user devices for which a content item interaction was detected have an application requiring login installed, then to calculate a total number of conversions, the number of detected conversions is divided by 0.2 to determine the total number of conversions.

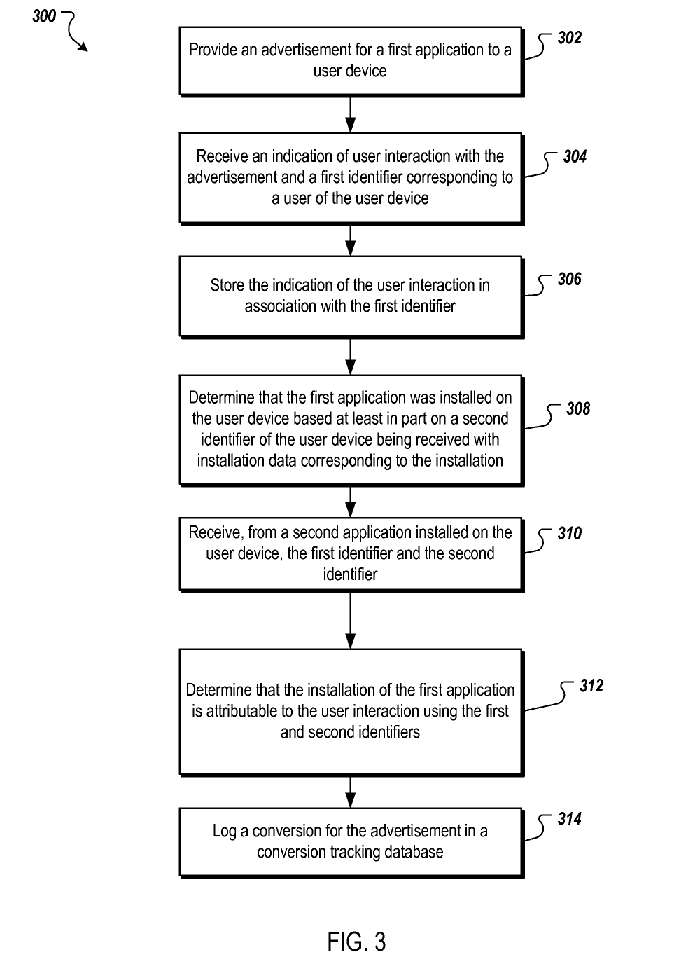

FIG. 3 is a flow chart of an example process 300 for identifying application installation conversions. The process 300 can be performed by one or more data processing apparatus, such as the content distribution system 110, the content distribution system 206, or another data processing apparatus. Operations of the process 300 can be implemented by execution of instructions stored on a non-transitory computer readable medium. Execution of the instructions causes one or more data processing apparatus to perform operations of the process 300.

An advertisement for a first application is provided to a user device (302). In some implementations, the advertisement is provided in response to a request for a content item received by a content distribution system. The content distribution system can provide the advertisement for presentation in a content item slot along with a publisher resource. For example, the advertisement can be a banner ad that is displayed to the right of a news article. As another example, the advertisement can be a video advertisement (e.g., a commercial) that is presented prior to, during, or after video content provided by a publisher. The content distribution system can have a business relationship with an application provider and provide the advertisement for the first application on behalf of the application provider.

An indication of user interaction with the advertisement and a first identifier corresponding to a user of the user device are received (304). For example, the content distribution system can receive a communication from the user device that indicates that the user of the user device has interacted with the advertisement (e.g., by selecting the advertisement, mousing over the advertisement, interacting with the advertisement using voice input, etc.) and a first identifier that is unique to the user of the user device.

In some implementations, the communication can also include an identifier for the advertisement. For example, a unique ID can be associated with the advertisement, and the communication received from the user device can include the unique ID and indicate that a user has interacted with the advertisement identified by the unique ID.

The first identifier can be a user ID that is associated with a user account for one or more services (e.g., email service, video sharing service, social network, etc.). In some implementations, the user account can require or allow for the user to log in using a username and a password. The first identifier can be an ID that is unique to the user and can be used to identify the user from among other users (such as a unique character string assigned to the user's account to uniquely identify the user's account from among other user accounts). In some implementations, rather than receiving a first identifier that corresponds to the user, the content delivery system can receive an identifier that uniquely identifies an application that is installed on the user device. The content delivery system can use the unique application identifier to determine that a user has interacted with the advertisement within the identified application.

The indication of the user interaction is stored in association with the first identifier (306). For example, the content delivery system can associate the user interaction with the advertisement with the first identifier in a database of advertisement interactions. In some implementations, an identifier for the advertisement can also be stored. In some implementations, the association stored within the database of advertisement interactions includes a timestamp indicating when the user interaction with the advertisement occurred.

A determination that the first application was installed on the user device is made (308). The determination is based at least in part on a second identifier of the user device being received with installation data corresponding to the installation. For example, upon user interaction with the advertisement at the user device (e.g., selection of the advertisement by the user) in addition to the information indicating the user interaction and the first identifier being transmitted to the content distribution system, the user interaction can also cause the user to be directed to an application store that can allow the user to purchase the advertised first application. The user can then purchase or download the first application and install the first application on the user device.

Upon installation code included as part of or in association with the first application can cause the user device to transmit an indication of installation of the application to the content delivery system. The installation data transmitted by the user device in response to installation of the first application can include an indication that the application was installed on the user device, and the second identifier that uniquely identifies the user device. The installation data can also include a timestamp indicating when the first application was installed on the user device.

In some implementations, the application provider can include a software development kit integrated into the first application that causes the application to transmit the installation data to the content distribution system. The application provider can include the software development kit with the first application to allow the content distribution provider to identify application installations. In some implementations, the association between the installation of the application on the user device and the second identifier is stored by the content distribution system.

The first identifier and the second identifier are received from a second application installed on the user device (310). For example, a second application installed on the user device can allow the user to log in using the same credentials as the previous login to the user account for the service discussed with reference to block 304. This log in by the user allows the second application to access the first identifier that is associated with the user. The second application can also access the second identifier that uniquely identifies the user device. The second application can transmit the first and second identifiers to the content distribution system along with another communication. For example, the second application can transmit the first and second identifiers to the content distribution system along with a request for content. In some implementations, the second application is distinct from the first application. In some implementations, the first and second applications are the same application.

A determination that the installation of the first application is attributable to the user interaction is made using the first and second identifiers (312). For example, upon receiving the first and second identifiers from the second application installed on the user device, the content distribution system can use the first identifier to identify that the user interaction with the first advertisement had previously occurred. The content distribution system can use the second identifier to identify that the first application had been installed on the user device. The content distribution can then associate the installation of the first application on the user device with the user interaction with the advertisement by the user based on the first identifier and the second identifier being received as part of the same communication from the second application installed on the user device. If the first identifier is not identified in association with the advertisement, then a determination can be made that the installation of the first application, which is associated with the second identifier, is not attributable to the advertisement or a user interaction with the advertisement.

A conversion for the advertisement is logged in a conversion database (314). For example, the content distribution system can use the identified association between the installation of the first application on the user device with the user interaction with the advertisement to determine that a conversion has occurred (e.g., a purchase or download and successful installation of the first application in response to presentation of the advertisement to the user). The content distribution system then logs the conversion in a conversion database. After logging the conversion, information regarding the association between the first identifier and the user interaction with the advertisement and the association between the second identifier and the installation of the first application can be deleted by the content distribution provider. The conversion can be detected and logged without a persistent map between the first identifier and the second identifier being created.

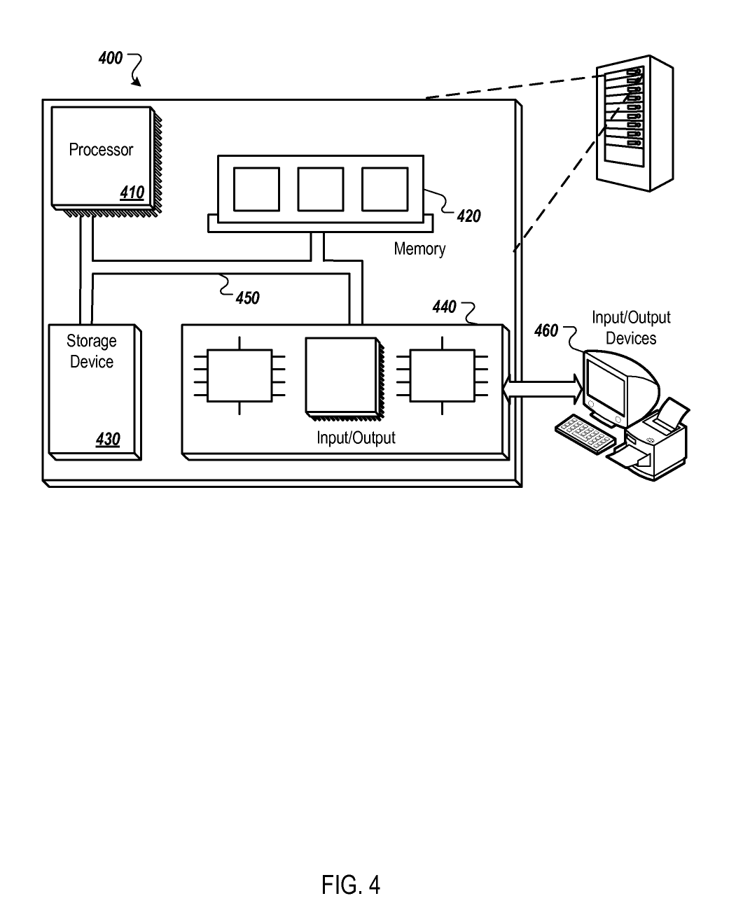

FIG. 4 is block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magnetooptical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous

What is claimed is:

1. A method comprising:
providing, for presentation at a user device, an advertisement for a first application;
receiving (1) an indication of a user interaction with the advertisement that was presented at the user device and (2) a user identifier corresponding to the user device;
storing the indication of the user interaction in association with the user identifier;
determining, by one or more data processing apparatus, that the first application was installed on the user device, based at least in part on a device identifier of the user device being received with installation data corresponding to the installation, the device identifier being different from the user identifier;
receiving, from a second application installed on the user device, (1) the user identifier and (2) the device identifier of the user device;
determining, based on the determination that the first application was installed on the user device, receipt of the user identifier and device identifier from the second application and the stored association between the user identifier and the user interaction with the advertisement, that the installation of the first application is attributable to the user interaction; and
recording, in response to the determination that the installation of the first application is attributable to the user interaction, a conversion for the advertisement in a database.

2. The method of claim 1, wherein the first application is distinct from the second application.

3. The method of claim 1, wherein the user identifier is a unique user ID for a user account, and the user account is a user account for at least one of an email service, a photo sharing service, a video sharing service, or a social network.

4. The method of claim 3, wherein the user is logged in to the user account when the indication of the user interaction with the advertisement and the user identifier are received.

5. The method of claim 1, further comprising, in response to determining that the installation of the first application is attributable to the user interaction, deleting the stored indication of the user interaction and the associated stored user identifier.

6. The method of claim 1, further comprising, in response to determining that the installation of the first application is attributable to the user interaction, deleting a record of the device identifier.

7. A computer storage medium encoded with a computer program, the program comprising instructions that when executed by one or more data processing apparatus cause the one or more data processing apparatus to perform operations comprising:
providing, for presentation at a user device, an advertisement for a first application;
receiving (1) an indication of a user interaction with the advertisement that was presented at the user device and (2) a user identifier corresponding to the user device;
storing the indication of the user interaction in association with the user identifier;
determining, by one or more data processing apparatus, that the first application was installed on the user device, based at least in part on a device identifier of the user device being received with installation data corresponding to the installation, the device identifier being different from the user identifier;
receiving, from a second application installed on the user device, (1) the user identifier and (2) the device identifier of the user device;
determining, based on the determination that the first application was installed on the user device, receipt of the user identifier and device identifier from the second application and the stored association between the user identifier and the user interaction with the advertisement, that the installation of the first application is attributable to the user interaction; and
recording, in response to the determination that the installation of the first application is attributable to the user interaction, a conversion for the advertisement in a database.

8. The computer storage medium of claim 7, wherein the first application is distinct from the second application.

9. The computer storage medium of claim 7, wherein the user identifier is a unique user ID for a user account, and the user account is a user account for at least one of an email service, a photo sharing service, a video sharing service, or a social network.

10. The computer storage medium of claim 9, wherein the user is logged in to the user account when the indication of the user interaction with the advertisement and the user identifier are received.

11. The computer storage medium of claim 7, the operations further comprising, in response to determining that the installation of the first application is attributable to the user interaction, deleting the stored indication of the user interaction and the associated stored user identifier.

12. The computer storage medium of claim 7, the operations further comprising, in response to determining that the installation of the first application is attributable to the user interaction, deleting a record of the device identifier.

13. A system comprising:
a data store storing one or more advertisements; and
one or more computers that interact with the data store and execute instructions that cause the one or more computers to perform operations comprising:
providing, for presentation at a user device, an advertisement, selected from the data store, for a first application;
receiving (1) an indication of a user interaction with the advertisement that was presented at the user device and (2) a user identifier corresponding to the user device;
storing the indication of the user interaction in association with the user identifier;
determining, by one or more data processing apparatus, that the first application was installed on the user device, based at least in part on a device identifier of the user device being received with installation data corresponding to the installation, the device identifier being different from the user identifier;
receiving, from a second application installed on the user device, (1) the user identifier and (2) the device identifier of the user device;
determining, based on the determination that the first application was installed on the user device, receipt of the user identifier and device identifier from the second application and the stored association between the user identifier and the user interaction with the advertisement, that the installation of the first application is attributable to the user interaction; and
recording, in response to the determination that the installation of the first application is attributable to the user interaction, a conversion for the advertisement in a database.

14. The system of claim 13, wherein the first application is distinct from the second application.

15. The system of claim 13, wherein the user identifier is a unique user ID for a user account, and the user account is a user account for at least one of an email service, a photo sharing service, a video sharing service, or a social network.

16. The system of claim 15, wherein the user is logged in to the user account when the indication of the user interaction with the advertisement and the user identifier are received.

17. The system of claim 13, the operations further comprising, in response to determining that the installation of the first application is attributable to the user interaction, deleting the stored indication of the user interaction and the associated stored user identifier.

18. The system of claim 13, the operations further comprising, in response to determining that the installation of the first application is attributable to the user interaction, deleting a record of the device identifier.
